(19) United States
(12) Patent Application Publication
(10) Pub. No.: US 2008/0045625 A1
(43) Pub. Date: Feb. 21, 2008

(54) Method For Producing Polymers By Dispersion Polymerization

(75) Inventors: Dennis Losch, Altrip (DE); Christian Hubert Weidl, Mannheim (DE); Volker Seidl, Mannheim (DE); Hans-Ulrich Moritz, Bendestorf (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT a German corporation, Ludwigshafen (DE)

(21) Appl. No.: 11/660,633

(22) PCT Filed: Aug. 9, 2005
(86) PCT No.: PCT/EP05/08606

§ 371 Date: Feb. 20, 2007

(30) Foreign Application Priority Data
Sep. 2, 2004 (DE) 10 2004 042 955.3

(51) Int. Cl. B01J 2/00; C08F 2/48; C08F 220/20

(52) U.S. Cl. 522/167; 422/131; 526/258

(57) ABSTRACT

Process for producing polymers by spray polymerization wherein the aqueous monomer solution comprises from 0.01% to 0.2% by weight, based on the monomer, of at least one crosslinker, the use of the polymers for thickening liquids and also apparatus for producing polymers by spray polymerization.

The present invention relates to a process for producing polymers by spray polymerization, to their use for thickening liquids and to a device for producing polymers by spray polymerization.

Further embodiments of the present invention are discernible from the claims, the description and the examples. It will be appreciated that the hereinbefore identified and the hereinafter still to be more particularly described features of the subject matter of the present invention are utilizable not only in the particular combination indicated but also in other combinations without leaving the realm of the present invention.

WO-A-99/14246 describes the production of polymers by emulsion polymerization in the presence of ionizable stabilizers. The polymer dispersions are spray dried. The polymer powders thus obtained can be used as thickeners or flocculants.

EP-A-0 398 151 describes the production of polymeric thickeners by spray drying aqueous polymer solutions or dispersions.

DE-A-195 06 287 describes the production of thickeners for print pastes. The thickeners are produced by emulsion polymerization, azeotropically dewatered and filtered.

GB-A-0 777 306 describes the production of polymers by spray polymerization. The reaction is catalyzed by amides, such as acrylamide, acetamide and partially hydrolyzed polyacrylonitrile. The polymers can also be used as thickeners for synthetic resin dispersions.

U.S. Pat. No. 3,644,305 discloses a spray polymerization process whereby low molecular weight polymers can be produced. The polymerization is carried out at elevated pressure.

According to the WO-A-96/40427 patent application, the spray polymerization process is carried out by spraying monomer solutions into a heated atmosphere which is essentially static. In the process, the monomers in the sprayed droplets polymerize and the droplets are dried at the same time. At reduced pressure, the water content in the polymer spheres produced is distinctly reduced, but the polymer particles have a rough surface. At elevated pressure, smooth polymer spheres are obtained. The application teaches that the particle size can be adjusted via the nozzle orifice.

J. Appl. Pol. Sci., volume 87, 2003, pages 1034 to 1043, and also J. Appl. Pol. Sci., volume 88, 2003, pages 928 to 935 describe the spray polymerization of sodium acrylate. Persulfate only was used as initiator. The experiments were carried out in an air atmosphere in countercurrent. The thickening effect of the polymers obtained was minimal. Despite high crosslinker concentrations, the viscosity of a 10% by weight aqueous solution was not more than 3900 mPas.

The present invention has for its object to provide an improved process for producing polymeric thickeners.

We have found that this object is achieved by a process for spray polymerization of a monomer solution comprising

a) at least one water soluble ethylenically unsaturated monomer,

b) at least one crosslinker,

c) at least one initiator,

d) water,

wherein the monomer solution comprises from 0.01% to 0.2% by weight and preferably 0.05% to 0.15% by weight of crosslinker b), based on the monomer a).

The reaction can be carried out in the presence of an inert carrier gas, in which case inert is to be understood as meaning that the carrier gas cannot react with the constituents of the monomer solution. The inert gas is preferably nitrogen. The oxygen content of the inert carrier gas is advantageously below 1% by volume, preferably below 0.5% by volume and more preferably below 0.1% by volume.

The inert carrier gas can be led through the reaction space cocurrently with or countercurrently to the free-falling droplets of the monomer solution, preferably cocurrently. Preferably, the carrier gas is at least partly, preferably to an extent of not less than 50% and more preferably to an extent of not less than 75%, returned into the reaction space as a cycle gas after one pass. Customarily, a portion of the carrier gas, preferably not less than 10%, is removed from the system after every pass.

The gas velocity is preferably such that flow in the reactor is laminar in that for example there are no convection eddies opposite to the general direction of flow, and is for example in the range from 0.02 to 1.5 m/s and preferably in the range from 0.05 to 0.4 m/s.

The reaction temperature is preferably 70 to 250° C., more preferably 80 to 190° C. and most preferably 90 to 140° C.

The concentration of monomer a) in the monomer solution is typically in the range from 2% to 80% by weight, preferably in the range from 5% to 70% by weight and more preferably in the range from 10% to 60% by weight.

The solubility of monomer a) in water is typically not less than 1 g/100 g of water, preferably not less than 5 g/100 g water, more preferably not less than 25 g/100 g of water and most preferably not less than 50 g/100 g of water.

Ethylenically unsaturated monomers a) are for example ethylenically unsaturated C₃-C₆-carboxylic acids. These compounds are for example acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid and fumaric acid and also the alkali metal or ammonium salts of these acids.

Further polymerizable monomers a) are acrylamidopropanesulfonic acid, vinylphosphonic acid and/or alkali metal or ammonium salts of vinylsulfonic acid. The other acids can likewise be used either in unneutralized form or in partially or 100% neutralized form during the polymerization.

Monoethylenically unsaturated sulfonic or phosphonic acids are also useful, examples being allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, allylphosphonic acid, styrenesulfonic acid and 2-acrylamido-2-methylpropanesulfonic acid.

Further monomers a) are for example acrylamide, methacrylamide, crotonamide, acrylonitrile, methacrylonitrile, dimethylaminoethyl methacrylate, dimethylaminoethyl acrylate, dimethylaminopropyl acrylate, diethylaminopropyl acrylate, dimethylamino-butyl acrylate, dimethylaminoethyl methacrylate, diethylaminoethyl methacrylate, dimethylaminoneopentyl acrylate and dimethylaminoneopentyl methacrylate and also their quarternization products, for example with methyl chloride, hydroxyethyl acrylate, hydroxyethyl methacrylate, hydroxypropyl acrylate and hydroxypropyl methacrylate.

Further monomers a) are monomers which are obtainable by reaction of nitrogenous heterocycles and/or carboxamides, such as vinylimidazole, vinylpyrazole and also vinylpyrrolidone, vinylcaprolactam and vinylformamide, with acetylene and which can also be quaternized, for example with methyl chloride, and monomers obtainable by reaction of nitrogenous compounds, such as, for example, diallyldimethylammonium chloride, with allyl alcohol or allyl chloride.

It is further possible to use vinyl and allyl esters and also vinyl and allyl ethers, such as vinyl acetate, allyl acetate, methyl vinyl ether and methyl allyl ether as monomers a). The monomers a) can be used alone or mixed with each or one another, for example mixtures comprising two, three, four or more monomers a).

Preferred monomers a) are acrylic acid, methacrylic acid and also the alkali metal or ammonium salts of these acids, acrylamide, methacrylamide, acrylonitrile, methacrylonitrile, itaconic acid, vinylformamide, vinylpyrrolidone, vinylimidazole, quaternized vinylimidazole, vinyl acetate, sodium vinylsulfonate, vinylphosphonic acid, hydroxyethyl acrylate, hydroxyethyl methacrylate, 2-acrylamido-2-methylpropane-sulfonic acid, diallyldimethylammonium chloride and also mixtures thereof.

The monomers a) are preferably stabilized with a commercially available polymerization inhibitor, more preferably with a polymerization inhibitor which only acts together with oxygen, an example being hydroquinone monomethyl ether.

Commercially available polymerization inhibitors are polymerization inhibitors which are used as storage stabilizers in the respective monomers for product safety reasons. Examples of such storage stabilizers are hydroquinone, hydroquinone monomethyl ether, 2,5-di-tert-butylhydroquinone and 2,6-di-tert-butyl-4-methylphenol.

Preferred polymerization inhibitors require dissolved oxygen for optimum performance. Therefore, the polymerization inhibitors can be freed of dissolved oxygen prior to polymerization by inertization, i.e., flowing an inert gas, preferably nitrogen, through them. The oxygen content of the monomer solution prior to polymerization is preferably lowered to less than 1 weight ppm and more preferably to less than 0.5 weight ppm.

The monomers a) are polymerized in the presence of a crosslinker b) or of a combination of various crosslinkers. Crosslinkers are compounds having two or more polymerizable groups.

Suitable crosslinkers b) are for example (meth)acrylic esters of polyhydric alcohols which may have been alkoxylated with up to 100 and usually up to 50 ethylene oxide and/or propylene oxide units. Suitable polyhydric alcohols are in particular C₂-C₁₀-alkanepolyols having 2 to 6 hydroxyl groups, such as ethylene glycol, glycerol, trimethylolpropane, pentaerythritol or sorbitol. Preferred crosslinkers are polyethylene glycol diacrylate and polyethylene glycol dimethacrylates, which are each derived from polyethylene glycols (which may be considered as ethoxylated ethylene glycol) having a molecular weight in the range from 200 to 2000. Further usable crosslinkers b) are methylenebisacrylamide, trimethylolpropane triacrylate, trimethylolpropane trimethacrylate, ethylene glycol diacrylate, propylene glycol diacrylate, butanediol diacrylate, hexanediol diacrylate, hexanediol dimethacrylate or diacrylates and dimethacrylates of block copolymers formed from ethylene oxide and propylene oxide.

Useful crosslinkers b) further include diallyl carbonate, allyl carbonates or allyl ethers of polyhydric alcohols which may have been alkoxylated with up to 100, and usually up to 50 ethylene oxide and/or propylene oxide units, and allyl esters of polybasic carboxylic acids.

Allyl carbonates of polyhydric alcohols conform to the general formula I 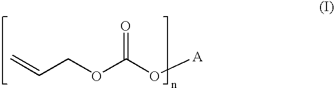
where A is the radical of a polyhydric alcohol which may have been alkoxylated with 0 to 100 and usually 0 to 50 ethylene oxide and/or propylene oxide units; and n represents the hydricness of the alcohol, for example an integer from 2 to 10 and preferably from 2 to 5. A particularly preferred example of such a compound is ethylene glycol di(allyl carbonate). Also suitable are particularly polyethylene glycol di(allyl carbonate)s which are derived from polyethylene glycols having a molecular weight in the range from 200 to 2000.

Preferred examples of allyl ethers are: polyethylene glycol diallyl ethers which are derived from polyethylene glycols having a molecular weight from 200 to 2000; pentaerythritol triallyl ether or trimethylolpropane diallyl ether. It is further possible to use reaction products of ethylene glycol diglycidyl ether or polyethylene glycol glycidyl ether with 2 mol of allyl alcohol and/or pentaerythritol triallyl ether.

A suitable allyl ester of a polyfunctional carboxylic acid is for example diallyl phtalate.

The monomers are polymerized with each or one another in aqueous solution in the presence of initiators c).

The initiators c) are used in customary amounts, for example in amounts from 0.001% to 5% by weight and preferably from 0.01% to 1% by weight, based on the monomers to be polymerized.

Useful initiators c) include all compounds which disintegrate into free radicals under the polymerization conditions, examples being peroxides, hydroperoxides, hydrogen peroxide, persulfates, azo compounds and redox initiators. Preference is given to the use of water-soluble initiators. In some cases it is advantageous to use mixtures of various initiators, examples being mixtures of hydrogen peroxide and sodium or potassium peroxodisulfate. Mixtures of hydrogen peroxide and sodium peroxodisulfate can be used in any proportion.

Useful organic peroxides are for example acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, di(2-ethylhexyl) peroxydicarbonate, dicyclohexyl peroxydicarbonate, di(4-tert-butylcyclohexyl) peroxydicarbonate, dimyristyl peroxydicarbonate, diacetyl peroxydicarbonate, allyl peresters, cumyl peroxyneodecanoate, tert-butyl per-3,5,5-tri-methylhexanoate, acetylcyclohexylsulfonyl peroxide, dilauryl peroxide, dibenzoyl peroxide and tert-amyl perneodecanoate.

Preferred initiators c) are azo compounds, examples being 2,2′-azobisisobutyronitrile, 2,2′-azobis(2,4-dimethylvaleronitrile) and 2,2′-azobis(4-methoxy-2,4-dimethyl-valeronitrile), especially water soluble azo initiators, examples being 2,2′-azobis{2-[1-(2-hydroxyethyl)-2-imidazolin-2-yl]propane}dihydrochloride, 2,2′-azobis-(2-amidinopropane) dihydrochloride, 2,2′-azobis[2-(2-imidazolin-2-yl)propane]dihydrochloride and 2,2′-azobis[2-(5-methyl-2-imidazolin-2-yl)propane]dihydrochloride. Very particular preference is given to 2,2′-azobis[2-(2-imidazolin-2-yl)propane]dihydrochloride and 2,2′-azobis[2-(5-methyl-2-imidazolin-2-yl)propane]dihydrochloride.

Redox initiators are also further preferred initiators c). In redox initiators, the oxidizing component is at least one of the peroxo compounds indicated above and the reducing component is for example ascorbic acid, glucose, sorbose, ammonium bisulfite, ammonium sulfite, ammonium thiosulfate, ammonium hyposulfite, ammonium pyrosulfite, ammonium sulfide, alkali metal bisulfite, alkali metal sulfite, alkali metal thiosulfate, alkali metal hyposulfite, alkali metal pyrosulfite, alkali metal sulfide or sodium hydroxymethylsulfoxylate. The reducing component in the redox catalyst is preferably ascorbic acid or sodium pyrosulfite. Based on the amount of monomers used in the polymerization, for example from 1×10⁻⁵ to 1 mol % is used of the reducing component of the redox catalyst.

It is particularly preferable to induce the polymerization through the action of high energy radiation, in which case it is customary to use photoinitiators as initiator c). Useful photoinitators include for example α-splitters, H-abstracting systems or else azides. Examples of such initiators are benzophenone derivatives such as Michler's ketone, phenanthrene derivatives, fluorene derivatives, anthraquinone derivatives, thioxanthone derivatives, coumarin derivatives, benzoin ethers and derivatives thereof, azo compounds, such as the free-radical formers mentioned above, substituted hexaarylbisimidazoles or acylphosphine oxides, especially 2-hydroxy-2-methyl-propiophenone (Darocure® 1173). Examples of azides are 2-(N,N-dimethylamino)ethyl 4-azidocinnamate, 2-(N,N-dimethylamino)ethyl 4-azidonaphthyl ketone, 2-(N,N-di-methylamino)ethyl 4-azidobenzoate, 5-azido-1-naphthyl 2′-(N,N-dimethylamino)ethyl sulfone, N-(4-sulfonylazidophenyl)maleimide, N-acetyl-4-sulfonylazidoaniline, 4-sulfonylazidoaniline, 4-azidoaniline, 4-azidophenacyl bromide, p-azidobenzoic acid, 2,6-bis(p-azidobenzylidene)cyclohexanone and 2,6-bis(p-azidobenzylidene)-4-methyl-cyclohexanone.

Particularly preferred initiators c) are azo initiators, such as 2,2′-azobis[2-(2-imidazolin-2-yl)propane]dihydrochloride and 2,2′-azobis[2-(5-methyl-2-imidazolin-2-yl)propane]dihydrochloride, and photoinitiators, such as 2-hydroxy-2-methylpropiophenone and 1-[4-(2-hydroxyethoxy)phenyl]-2-hydroxy-2-methyl-1-propan-1-one, redox initiators, such as sodium persulfate/hydroxymethylsulfinic acid, ammonium peroxodisulfate/hydroxymethylsulfinic acid, hydrogen peroxide/hydroxymethylsulfinic acid, sodium persulfate/ascorbic acid, ammonium peroxodisulfate/ascorbic acid and hydrogen peroxide/ascorbic acid, photoinitiators, such as 1-[4-(2-hydroxyethoxy)-phenyl]-2-hydroxy-2-methyl-1-propan-1-one, and also mixtures thereof.

The monomer solution comprises water as component d).

The pH of the monomer solution is not decisive. But, to meet product requirements, the pH of the polymer of the present invention can be adjusted to the desired range via the pH of the monomer solution. Polymers for cosmetic applications, for example, should have a pH of around 7.

The reaction is preferably carried out in apparatuses which are also suitable for spray drying. Such reactors are described for example in K. Masters, Spray Drying Handbook, 5th Edition, Longman, 1991, pages 23 to 66.

One or more spray nozzles can be used in the process of the present invention. Usable spray nozzles are not subject to any restriction. The liquid to be spray dispensed may be fed to such nozzles under pressure. The atomizing of the liquid to be spray dispensed may in this case be effected by decompressing the liquid in the nozzle bore after the liquid has reached a certain minimum velocity. Also useful for the purposes of present invention are one-material nozzles, for example slot nozzles or swirl or whirl chambers (full cone nozzles, available for example from Düsen-Schlick GmbH, Germany, or from Spraying Systems Deutschland GmbH, Germany).

Preference for the purposes of the present invention is given to full cone nozzles. Of these, those having a spray cone opening angle in the range from 60 to 180° are preferred and those having an opening angle in the range from 90 to 120° are particularly preferred. For the purposes of the present invention, the average droplet diameter which results on spraying is typically less than 1000 μm, preferably less than 200 μm, more preferably less than 100 μm and customarily greater than 10 μm, preferably greater than 20 μm and more preferably greater than 50 μm, and can be determined by customary methods, such as light scattering, or by reference to the characteristic curves available from nozzle makers. The throughput per spray nozzle is advantageously in the range from 0.1 to 10 m³/h and frequently in the range from 0.5 to 5 m³/h.

The droplet diameter resulting in the course of spraying is advantageously in the range from 10 to 1 000 μm, preferably in the range from 10 to 500 μm, more preferably in the range from 10 to 150 μm and most preferably in the range from 10 to 45 μm.

The reaction can also be carried out in apparatuses in which the monomer solution can free fall in the form of monodisperse droplets. Suitable for this purpose are apparatuses as described for example in U.S. Pat. No. 5,269,980 column 3 lines 25 to 32.

Dropletization through laminar jet disintegration as described in Rev. Sci. Instr., volume 38 (1966), pages 502 to 506 is likewise possible.

Dropletization is preferred to spraying, especially when photoinitiators are used. Dropletization in the process of the present invention provides polymeric thickeners having a low fraction of dust, an optimum bulk density and good flowability.

If, however, high throughputs of monomer solution are desired, spraying of the monomer solution into the reaction space is preferred.

The reaction space of the polymerization reactor can be carried out in overpressure or in underpressure, an underpressure of up to 100 mbar below ambient being preferred.

The polymerization rate and the drying rate typically have different temperature dependencies. This can mean, for example, that the sprayed droplets dry before the desired conversion has been achieved. It is therefore advantageous to control the reaction rate and the drying rate separately.

The drying rate can be controlled via the water vapor content of the inert gas. The water vapor content of the inert gas is generally up to 90% by volume and preferably up to 50% by volume.

The polymerization rate can be controlled through the identity and amount of the initiator system used.

The use of azo compounds or redox initiators as initiators c) is advantageous for controlling the polymerization rate. The starting characteristics of the polymerization are better controllable with azo compounds or redox initiators via the choice of initiator, initiator concentration and reaction temperature than for example with pure peroxide initiators.

Photoinitiators are particularly advantageous. When photoinitiators are used, the drying rate can be controlled to the desired value via the temperature without thereby significantly influencing the free-radical formation process at the same time.

The carrier gas is advantageously preheated to the reaction temperature of 70 to 250° C., preferably 80 to 190° C. and more preferably 90 to 140° C. upstream of the reactor.

The reaction offgas, i.e., the carrier gas leaving the reaction space, can be cooled down in a heat exchanger for example. Water and unconverted monomer condense in the process. Thereafter, the reaction offgas can be at least partially reheated and returned into the reactor as recycle gas. Preferably, the recycle gas is cooled down such that the cooled recycle gas has the water vapor fraction desired for the reaction. A portion of the reaction offgas can be removed from the system and replaced by fresh carrier gas, in which case unconverted monomers present in the reaction offgas can be separated off and recycled.

Particular preference is given to an integrated energy system whereby a portion of the heat rejected in the cooling of the offgas is used to heat up the cycle gas.

The reactors can be trace heated. Any trace heating is adjusted such that the wall temperature is not less than 5° C. above reactor internal temperature and condensation at reactor walls is reliably avoided.

The reaction product can be removed from the reaction space in a conventional manner, preferably at the base via a conveying screw, and if appropriate be dried to the desired residual moisture content and to the desired residual monomer content.

The present invention further provides apparatus for producing polymers by spray polymerization, comprising
i) a heatable reaction space,
ii) at least one apparatus for droplet generation in the upper region of the reaction space i),
iii) at least one carrier gas feed in the upper portion of the reaction space i),
iv) at least one carrier gas preheater,
v) at least one carrier gas outlet in the lower portion of the reaction space i),
vi) if appropriate at least one means for returning at least a portion of the removed carrier gas from the carrier gas outlet v) to the carrier gas feed iii),
vii) at least one conveying device in the lower region of the reaction space i) for product discharge, and
viii) at least one source of radiation, preferably in the upper portion of the reaction space i),
   the upper region of the reaction space being the upper 30%, preferably the upper 20% and particularly the upper 10% of the reaction space volume and lower region of the reaction space being the lower 30%, preferably the lower 20% and particularly the lower 10% of the reaction space volume.

The means vi) comprises for example a compressor, a rate meter and an adjustable valve. The compressor raises the pressure of the carrier gas and thus makes it possible to return it to the carrier gas feed iii). The returned carrier gas rate can be set via the rate meter and the valve.

The source of radiation is not subject to any restriction; preferably the source of radiation is coordinated with the photoinitiator used. Preference is given to using UV lamps, preferably having a power output in the range from 0.5 to 20 kW and more preferably in the range from 2 to 10 kW, examples being iron-doped mercury lamps.

The process of the present invention advantageously combines the production and drying of a polymeric thickener in one operation, wherein the heat of polymerization can simultaneously be used for drying.

The process of the present invention makes it possible to produce polymeric thickeners which, owing to their small particle size and the associated large surface area, are fast dissolving and at the same time, owing to the droplet size set in the course of the spraying of the monomer solution, have a low fraction of fine dust, especially particles having a size of less than 10 μm.

The process of the present invention can also be used to produce smaller polymeric particles which are subsequently phlegmatized in a conventional manner, for example by suspending in technical-grade white oil.

The polymeric thickeners producible by the process of the present invention are useful for thickening liquids, especially aqueous systems.

The polymeric thickeners obtainable by the process of the present invention are water soluble, although in certain circumstances slightly cloudy colloidal solutions can be obtained as well. The thickened liquids produced using the polymeric thickeners produced by the process of the present invention do not comprise particulate structures.

If, for example, water is thickened using a polymeric thickener produced by the process of the present invention and the thickened solution is adjusted to a viscosity of less than 100 mPas (as measured according to German standard specification DIN 51562) by addition of water, filtration through a filter having a pore size of about 5 μm (for example by means of an S&S 589 Schwarzband filter paper from Schleicher & Schull) will not leave a detectable residue. The amount of residue can be determined by rinsing with water, drying and backweighing.

The polymeric thickeners producible by a process of the present invention are useful as thickeners for aqueous systems, examples being paper coating slips, pigment print pastes and waterborne coatings such as architectural coatings. They are also useful in cosmetics, examples being hair cosmetics such as conditioners or hair setting compositions or as thickeners for cosmetic formulations and for surface treatment of leather.

The viscosity of 2% by weight aqueous solutions comprising polymers produced by the process of the present invention is not less than 5000 mPas, preferably not less than 10 000 mPas and more preferably not less than 20 000 mPas at 23° C.

### EXAMPLES

### Example 1

### Comparative Example

7.8 kg of acrylic acid, 22 g of Irgacure® 2959 (1-[4-(2-hydroxyethoxy)phenyl]-2-hydroxy-2-methyl-1-propan-1-one from Ciba Spezialitätenchemie, Switzerland) and 12 g of 2,2′-azobis(N,N′-dimethyleneisobutyramidines) dihydrochloride (V44 azo initiator from Wako Deutschland, Germany) were dissolved in 10 kg of water. This solution was spray dispensed in a heated spray tower 8 m high and 2 m wide filled with a nitrogen atmosphere (100° C., gas velocity 0.1 m/s in cocurrent). In the top third of the spray tower the droplets traveled past 6 iron-doped mercury UV lamps (6 kW each). A dry white powder was obtained at the base of the spray tower. The average particle size was 11 μm. This powder formed a clear solution in water. A 1% by weight solution had a pH of 7 and a viscosity of 2000 mPas.

### Example 2

7.8 kg of acrylic acid, 7.8 g of polyethylene glycol diacrylate 400, 22 g of Irgacure® 2959 (1-[4-(2-hydroxyethoxy)phenyl]-2-hydroxy-2-methyl-1-propan-1-one from Ciba Spezialitätenchemie, Switzerland) and 12 g of 2,2′-azobis(N,N′-dimethylene-isobutyramidines) dihydrochloride (V44 azo initiator from Wako Deutschland, Germany) were dissolved in 10 kg of water. This solution was spray dispensed in a heated spray tower 8 m high and 2 m wide filled with a nitrogen atmosphere (100° C., gas velocity 0.1 m/s in cocurrent). In the top third of the spray tower the droplets traveled past 6 iron-doped mercury UV lamps (6 kW each). A dry white powder was obtained at the base of the spray tower. The average particle size was 12 μm. This powder formed a clear solution in water. A 1% by weight solution had a pH of 7 and a viscosity of 41 000 mPas.

### Example 3

7.0 kg of acrylic acid, 0.8 g of acrylamide, 7.8 g of polyethylene glycol diacrylate 400, 22 g of Irgacure® 2959 (1-[4-(2-hydroxyethoxy)phenyl]-2-hydroxy-2-methyl-1-propan-1-one from Ciba Spezialitätenchemie, Switzerland) and 12 g of 2,2′-azobis(N,N′-di-methyleneisobutyramidines) dihydrochloride (V44 azo initiator from Wako Deutschland, Germany) were dissolved in 10 kg of water. This solution was spray dispensed in a heated spray tower 8 m high and 2 m wide filled with a nitrogen atmosphere (100° C., gas velocity 0.1 m/s in cocurrent). In the top third of the spray tower the droplets traveled past 6 iron-doped mercury UV lamps (6 kW each). A dry white powder was obtained at the base of the spray tower. The average particle size was 12 μm. This powder formed a clear solution in water. A 1% by weight solution had a pH of 7 and a viscosity of 36 000 mPas.

### Example 4

7.0 kg of acrylic acid, 0.8 g of acrylamide, 7.8 g of polyethylene glycol diacrylate 400 and 33 g of 2,2′-azobis(N,N′-dimethyleneisobutyramidines) dihydrochloride (V44 azo initiator from Wako Deutschland, Germany) were dissolved in 10 kg of water. This solution was spray dispensed in a heated spray tower 8 m high and 2 m wide filled with a nitrogen atmosphere (120° C., gas velocity 0.1 m/s in cocurrent). A dry white powder was obtained at the base of the spray tower. The average particle size was 15 μm. This powder formed a clear solution in water. A 1% by weight solution had a pH of 7 and a viscosity of 32 000 mPas.

### Example 5

33 g of 2,2′-azobis(N,N′-dimethyleneisobutyramidines) dihydrochloride (V44 azo initiator from Wako Deutschland, Germany) and 7.8 g of polyethylene glycol diacrylate 400 were dissolved in 20.8 kg of aqueous sodium acrylate solution (37.5%). This solution was spray dispensed in a heated spray tower 8 m high and 2 m wide filled with a nitrogen atmosphere (120° C., gas velocity 0.1 m/s in cocurrent). A dry white powder was obtained at the base of the spray tower. The average particle size was 15 μm. This powder formed a clear solution in water. A 1% by weight solution had a pH of 7 and a viscosity of 30 000 mPas.

### Example 6

33 g of 2,2′-azobis(N,N′-dimethyleneisobutyramidines) dihydrochloride (V44 azo initiator from Wako Deutschland, Germany), 0.8 kg of acrylamide and 4 g of polyethylene glycol diacrylate 400 were dissolved in 18.7 kg of aqueous sodium acrylate solution (37.5%) and 2.1 kg of water. This solution was spray dispensed in a heated spray tower 8 m high and 2 m wide filled with a nitrogen atmosphere (120° C., gas velocity 0.1 m/s in cocurrent). A dry white powder was obtained at the base of the spray tower. The average particle size was 14 μm. This powder formed a clear solution in water. A 1% by weight solution had a pH of 7 and a viscosity of 40 000 mPas.

### Example 7

33 g of 2,2′-azobis(N,N′-dimethyleneisobutyramidines) dihydrochloride (V44 azo initiator from Wako Deutschland, Germany), 7.8 g of polyethylene glycol diacrylate 400 and 0.8 kg of acrylic acid were dissolved in 18.7 kg of aqueous sodium acrylate solution (37.5%) and 2.1 kg of water. This solution was spray dispensed in a heated spray tower 8 m high and 2 m wide filled with a nitrogen atmosphere (120° C., gas velocity 0.1 m/s in cocurrent). A dry white powder was obtained at the base of the spray tower. The average particle size was 15 μm. This powder formed a clear solution in water. A 1% by weight solution had a pH of 7 and a viscosity of 37 000 mPas.

1. A process for producing a polymer by spray polymerization of a monomer solution comprising
a) at least one water soluble ethylenically unsaturated monomer,
b) from 0.01% to 0.2% by weight, based on the monomer a), of a crosslinker,
c) at least one initiator, and
d) water,
wherein the polymerization is carried out at 70° C. to 250° C. in the presence of an inert carrier gas which is preheated to a reaction temperature upstream of reactor having a reaction space, and the carrier gas is at least partly recycled into the reaction space after one pass.

2. The process according to claim 1 wherein at least 50% of the carrier gas is recycled into the reaction space after one pass.

3. The process according to claim 1 wherein the carrier gas is nitrogen.

4. The process according to 2 wherein the carrier gas passes concurrently through the reaction space.

5. The process according to claim 1 wherein the monomer a) is selected from the group consisting of acrylic acid, vinylpyrrolidone, quaternized vinylimidazole, acrylamide, quaternized dimethylaminoethyl acrylate, diallyldimethylammonium chloride, and mixtures thereof.

6. The process according to claim 1 wherein the initiator c) is selected from the group consisting of an azo compound, a redox initiator, and a photoinitiator.

7. The process according to claim 1 wherein the initiator c) is a photoinitiator.

8. The process according to claim 1 wherein a droplet size of the spray-dispensed monomer solution is adjusted such that the polymers obtained have a primary particle size in the range from 10 to 150 μm.

9. An apparatus for spray polymerization wherein a reaction space of a reactor comprises at least one source of radiation, and the apparatus comprises a carrier gas preheater and a carrier gas recycler.

10. The apparatus according to claim 9 wherein the carrier gas recycler comprises a compressor.

11. The process according to claim 3 wherein the carrier gas passes concurrently through the reaction space.
